(19) United States
(12) Patent Application Publication
(10) Pub. No.: US 2012/0327040 A1
(43) Pub. Date: Dec. 27, 2012

(54) IDENTIFIABLE STYLUS

(76) Inventors: David I. SIMON, San Francisco, CA (US); Jonah A. Harley, Mountain View, CA (US)

(21) Appl. No.: 13/166,699

(22) Filed: Jun. 22, 2011

(51) Int. Cl. G06F 3/033

(52) U.S. Cl. 345/179

(57) ABSTRACT

A stylus is disclosed. The stylus includes a shaft; a conductive tip at a distal end of the shaft; and control circuitry coupled to the conductive tip and configured to generate a modulated signal at the conductive tip to identify the stylus. The stylus can also include a switch coupled between the conductive tip and the shaft. The control circuitry can be further configured to control the switch to modulate a conductive path between the conductive tip and the shaft to generate the modulated signal.

### FIELD

This relates generally to touch sensing, and more particularly, to providing a stylus that can be distinguished from other types of touch objects by a touch sensitive device.

### BACKGROUND

Many types of input devices are available for performing operations in a computing system, such as buttons or keys, mice, trackballs, touch sensor panels, joysticks, touch pads, touch screens, and the like. Touch sensitive devices, and touch screens, in particular, are becoming increasingly popular because of their ease and versatility of operation as well as their declining price. Touch sensitive devices can include a touch sensor panel, which can be a clear panel with a touch sensitive surface, and a display device such as a liquid crystal display (LCD) that can be positioned partially or fully behind the panel, or integrated with the panel, so that the touch sensitive surface can substantially cover the viewable area of the display device. Touch sensitive devices can generally allow a user to perform various functions by touching or hovering over the touch sensor panel using one or more fingers, a stylus or other object at a location often dictated by a user interface (UI) including virtual buttons, keys, bars, displays, and other elements being displayed by the display device. In general, touch screens can recognize a touch event and the position of the touch event on the touch sensor panel, or a hover event and the position of the hover event on the touch sensor panel, and the computing system can then interpret the touch or hover event in accordance with the display appearing at the time of the event, and thereafter can perform one or more operations based on the event.

Touch screens can allow a user to perform various functions by touching the touch sensor panel using a finger, stylus or other object. More advanced touch screens are capable of detecting multiple touches simultaneously. In general, touch screens can recognize the position of the one or more touches on the touch sensor panel, and a computing system can then interpret the touches, either individually or as a single gesture in accordance with the display appearing at the time of the touch event, and thereafter can perform one or more actions based on the touch event.

Most existing touch screens are typically operated by a user's finger(s) and/or a stylus. Touch data collected by these touch screens primarily includes the location and movement of the object(s) touching the touch screen. The location and movement data determines the actions to be performed by the hosting device of the touch screen. However, none of the existing touch panels is capable of identifying a stylus by a unique touch signal.

### SUMMARY

This relates to a stylus that can be distinguished from a finger or other touch objects by a touch sensing device having a touch panel. Typically, when a finger is in contact with the touch panel, the touch panel may detect a relatively steady signal as long as the finger remains on the touch panel. However, a conventional stylus, which in some embodiments is essentially a conductive rod, can also produce a similar signal on the touch panel. Therefore, the touch panel cannot differentiate a touch by a finger from one by a conventional stylus, at least not based on the touch signal detected by the touch panel alone. As will be discussed in detail below, embodiments of the present disclosure introduce various types of styluses that can produce a pulsed touch signal at a predetermined frequency which allows a touch panel to recognize that it is receiving touch input from a stylus instead of other touch objects. In other words, the styluses disclosed herein can be identified by a touch panel by their unique touch signatures which are based on the modulated touch signals they generate.

As long as the touch signal from the stylus is modulated, it can be distinguished from the steady signal produced by a finger or other touch object. In one embodiment, the touch signal of the stylus can simulate a rapid tapping by the stylus on the touch panel without physically lifting the stylus from the surface of the touch panel. The speed of the tapping can be such that it cannot be readily reproduced by a human finger or any manually operated touch object. The pulsed touch signal can be generated by modulating a conductive path within the stylus, as detailed below.

Based on the pulsed touch signal it receives, a touch panel can determine that the touch object on its surface is a stylus rather than, for example, a human finger. This can allow the touch sensitive device to respond differently to the touches by different objects. For example, a touch by a stylus may initiate a different operation than a touch by a finger. On a multi-touch-enabled touch panel, two separate touches, one by a finger and the other by a stylus, can perform different tasks simultaneously.

In some embodiments, in addition to being used to identify a stylus, the pulsed signal can also be used to encode and transmit data, such as additional telemetry data about the stylus, to the touch sensitive device. This allows the touch sensitive device to improve its response to the touches detected on its touch panel.

### BRIEF DESCRIPTION OF THE DRAWINGS

FIG. 1 illustrates an exemplary stylus for use with a touch panel according to an embodiment of the disclosure.

FIG. 2 illustrates an exemplary stylus capable of generating a pulsed touch signature according to an embodiment of the disclosure.

FIG. 3 illustrates an exemplary stylus including a touch sensor according to an embodiment of the disclosure.

FIG. 4 illustrates an exemplary stylus including an accelerometer according to an embodiment of the disclosure.

FIG. 5 illustrates an exemplary stylus including a pushbutton according to an embodiment of the disclosure.

FIG. 6 illustrates an exemplary stylus including a pressure sensor according to an embodiment of the disclosure.

FIG. 7 illustrate an exemplary stylus including a retractable tip according to an embodiment of the disclosure.

FIG. 8 illustrates an exemplary stylus including a RLC circuit and a movable tip according to an embodiment of the disclosure.

FIG. 9 illustrates an exemplary computing system for use with a stylus according to an embodiment of the disclosure.

FIG. 10 illustrates an exemplary mobile telephone for use with a stylus according to an embodiment of the disclosure.

FIG. 11 illustrates an exemplary digital media player for use with a stylus according to an embodiment of the disclosure.

FIG. 12 illustrates an exemplary personal computer for use with a stylus according to an embodiment of the disclosure.

### DETAILED DESCRIPTION

In the following description of example embodiments, reference is made to the accompanying drawings in which it is shown by way of illustration specific embodiments that can be practiced. It is to be understood that other embodiments can be used and structural changes can be made without departing from the scope of the various embodiments.

This relates to a stylus that can be distinguished from a finger or other touch objects by a touch sensing device having a touch panel. Typically, when a finger is in contact with the touch panel, the touch panel may detect a relatively steady signal as long as the finger remains on the touch panel. However, a conventional stylus, which in some embodiments is essentially a conductive rod, can also produce a similar signal on the touch panel. Therefore, the touch panel cannot differentiate a touch by a finger from one by a conventional stylus, at least not based on the touch signal detected by the touch panel alone. As will be discussed in detail below, embodiments of the present disclosure introduce various types of styluses that can produce a pulsed touch signal at a predetermined frequency which allows a touch panel to recognize that it is receiving touch input from a stylus instead of other touch objects. In other words, the styluses disclosed herein can be identified by a touch panel by their unique touch signatures which are based on the modulated touch signals they generate.

As long as the touch signal from the stylus is modulated, it can be distinguished from the steady signal produced by a finger or other touch object. In one embodiment, the touch signal of the stylus can simulate a rapid tapping by the stylus on the touch panel without physically lifting the stylus from the surface of the touch panel. The speed of the tapping can be such that it cannot be readily reproduced by a human finger or any manually operated touch object. The pulsed touch signal can be generated by modulating a conductive path within the stylus, as detailed below.

Based on the pulsed touch signal it receives, a touch panel can determine that the touch object on its surface is a stylus rather than, for example, a human finger. This can allow the touch sensitive device to respond differently to the touches by different objects. For example, a touch by a stylus may initiate a different operation than a touch by a finger. On a multi-touch-enabled touch panel, two separate touches, one by a finger and the other by a stylus, can perform different tasks simultaneously.

In some embodiments, in addition to being used to identify a stylus, the pulsed signal can also be used to encode and transmit data, such as additional telemetry data about the stylus, to the touch sensitive device. This allows the touch sensitive device to improve its response to the touches detected on its touch panel.

Although some embodiments are described herein in terms of a stylus, it is to be understood that other input devices and/or pointing devices can be used according to various embodiments. Although some embodiments are described herein in terms of a touch panel, it is to be understood that other touch sensitive devices capable of sensing an object touching or hovering over the devices can be used according to various embodiments.

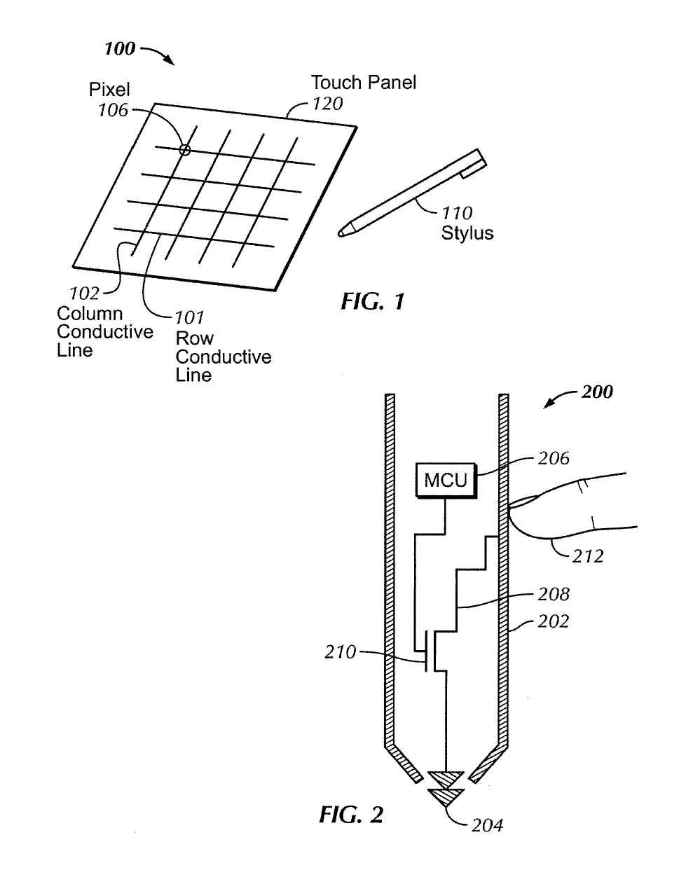

FIG. 1 illustrates an exemplary stylus for use with a touch panel according to various embodiments. In the example of FIG. 1, touch panel 120 can include an array of pixels 106 formed at the crossing points of conductive rows 101 and columns 102. Though FIG. 1 depicts the conductive elements 101, 102 in rows and columns, other configurations of conductive elements are also possible according to various embodiments.

When stylus 110 touches or hovers over a surface of the touch panel 120, the stylus can alter the capacitive coupling between one or more of the conductive rows 101 and/or columns 102 that can be detected by sensing circuitry (not shown). The stylus touch or hover can be represented in an image captured at the touch panel 120 and processed for input information regarding the stylus 110.

FIG. 2 illustrates an exemplary stylus 200 according to embodiment of this disclosure. The stylus 200 can include a shaft 202 and a tip 204 located at a distal end of the shaft. The shaft 202 and the tip 204 can both be conductive. However, the stylus 200 can be different from a conventional capacitive stylus in that the tip 204 can be isolated from the shaft 202, as illustrated in FIG. 2. In one embodiment, an insulator (not shown in FIG. 2) can be placed between the shaft 202 and the tip 204. Because the tip is electrically insolated from the shaft 202, a finger 212 or other parts of a human hand holding the stylus 200 cannot provide a ground for the conductive tip 204 through the shaft 202 of the stylus 200. In this embodiment, a conductive path 208 connecting the tip 204 to the shaft 202 can be provided within the bore of the stylus 200. In addition, the conductive path 208 can be modulated by a microcontroller (MCU) 206 to provide a pulsed signal that can be recognized by a touch panel when the stylus 200 is in contact with or hovering above the touch panel. In some embodiments, the MCU 206 can be a single application specific integrated circuit (ASIC) that can include one or more programmable processors, random access memory (RAM) or other non-transitory computer-readable storage media for storing program code executable by the processors, and input-output (I/O) ports. In some embodiments, the MCU 206 can also include data compression software and/or hardware.

As illustrated in FIG. 2, a pulsed touch signal can be generated by incorporating a switch 210, such as a field-effect transistor (FET), in the conductive path 208 connecting the conductive tip 204 to ground 212 and programming the MCU 206 to systematically turn on and off the switch 210. When the switch 210 is turned on, the conductive path 208 can connect the tip 204 of the stylus 200 to the shaft 202, and effectively to ground when the stylus 200 is being held by a grounded user 212. When the switch 210 is turned off by the MCU 206, the conductive path 208 can be broken, causing the tip 204 to be completely insolated from the shaft 202. Thus, by repeatedly turning on and off the switch 201 when the stylus 200 is on a touch panel, the MCU 206 can generate a discontinuous touch signal even though the tip 204 of the stylus 200 is continuously in contact with or hovering over the surface of the touch panel. In other words, the signal can be modulated between ground and a non-ground fixed potential such as a logic “high” voltage. In one embodiment, the MCU 206 can be connected to a power source (not shown in FIG. 2), such as a battery, built in the stylus. In another embodiment, power can be supplied from the power source in the touch sensing device via a cable connecting the stylus to the touch sensing device, or by inductive coupling.

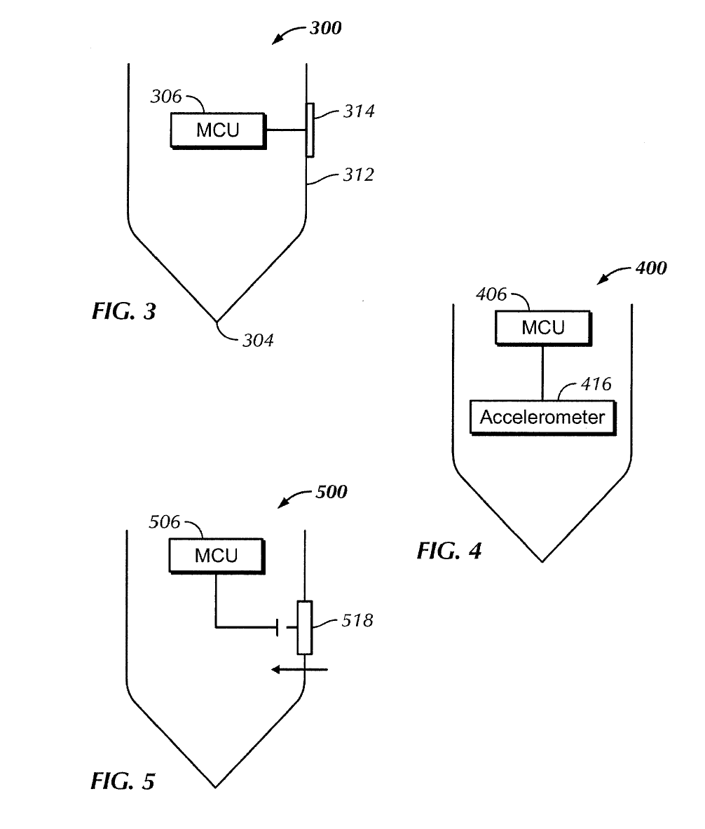

In one embodiment, the MCU 206 can always be in a power-on state such that the MCU 206 can constantly generate a modulated touch signal regardless of whether the stylus 200 is being used to interact with a touch panel. However, to conserve energy from the power source, the MCU 206 can be powered on only when the stylus is in use. For example, in the embodiment illustrated in FIG. 3, the stylus 300 can include a touch sensor 314 on the outer surface of its shaft 312. The touch sensor 314 can be any type of touch sensor, such as a capacitive or a resistive touch sensor. The touch sensor 314 can be located in an area of the shaft 312 which would likely be in contact with the user when the user is holding the stylus 300. In response to the touch sensor 314 detecting a touch, the MCU 306 can be switched to a power-on state and start to generate the modulated touch signal to the tip 304 of the stylus 300. When no touch has been detected by the touch sensor 314 for a predetermined period of time, the MCU 306 can terminate the modulated touch signal and/or be powered off.

The touch sensor 314 can be connected to a touch controller (not shown in FIG. 3) capable of processing touch data captured by the touch sensor 314. The touch sensor 314 can also be connected to the power source (not shown in FIG. 3) of the stylus. In other embodiments, multiple touch sensors or a multi-touch sensor can be placed at one or more locations on the outer surface of the stylus 300 to ensure that a detected touch is indeed from a user holding the stylus rather than, for example, a touch by another stationary object that just happened to be in contact with the stylus 300.

In yet another embodiment as illustrated in FIG. 4, the stylus 400 can include an accelerometer 416 connected to the MCU 406. The accelerometer 416 can detect movement of the stylus 400 when the stylus is picked up by the user. In response to the detected movement, the MCU 406 can initiate a modulated touch signal. When no movement is reported by the accelerometer 416 for a predetermined period of time, the MCU 406 can terminate the modulated touch signal.

In yet another embodiment as illustrated in FIG. 5, the stylus 500 can include a pushbutton 518. The pushbutton 518 can sense a push thereon and can transmit the push indication to the MCU 506 for processing. In response to the push indication, the MCU 506 can initiate the modulated touch signal. In response to another push indication, the MCU 506 can terminate the modulated touch signal.

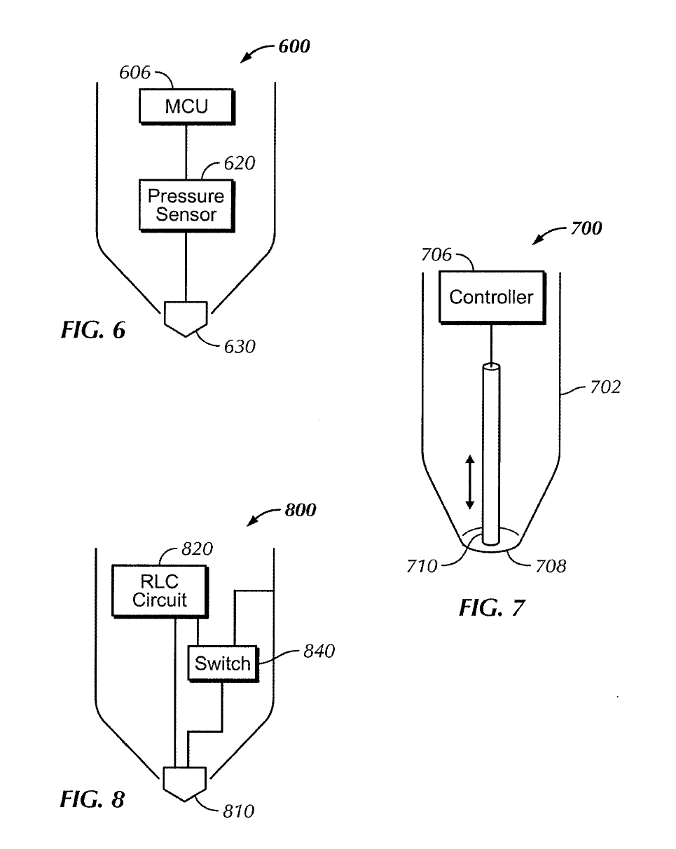

In yet another embodiment as illustrated in FIG. 6, the stylus 600 can include a pressure sensor 620. The pressure sensor 620 can sense a force being applied by the stylus to a surface and can transmit a force measurement to the MCU 606 for processing. In this embodiment, as illustrated in FIG. 6, the stylus 600 can include a movable tip 630. When the stylus 600 makes contact with a touch panel, the movable tip 630 can be forced upwards. The vertical distance traveled by the tip 630 as a result of the force can be used to determine an amount of pressure generated from the contact of the stylus 600 and the touch panel. In one embodiment, the pressure sensor can include a strain gauge. In another example, the pressure sensor can include a dome switch having a known capacitance. The movement of the stylus tip can cause a capacitance change in the dome switch and this capacitance change can reflect the amount of pressure between the stylus and the touch panel. In yet another embodiment, the pressure sensor can measure the force using a piezoelectric method. Other well-known methods can also be used to measure the force resulting from the contact by the stylus. The MCU 606 can initiate a pulsed touch signal in response to the force measurement which indicates that the stylus is being applied on a surface. When no force is detected by the pressure sensor 620, the MCU 606 can terminate the modulated touch signal.

In the aforementioned embodiments, the modulated touch signal can be generated by connecting and disconnecting the ground path from the conductive tip to the shaft of the stylus. In those embodiments, the tip of the stylus can remain in contact with the touch panel. In some of the other embodiments described below, the tip of the stylus can physically make and break contact with the touch panel to create a pulsed touch signal on the touch panel.

FIG. 7 illustrates an exemplary embodiment of a stylus 700 with a retractable conductive tip 710 enclosed in the shaft 702 of the stylus 700. The shaft 702 of the stylus 700 can be an insulator. The conductive tip 710 can be mechanically driven by a controller 706. When in use, the conductive tip 710 can be periodically extended from the opening 708 to make contact with a touch panel (not shown in FIG. 7), creating a repeated tapping effect on the touch panel. Essentially, this embodiment works in a similar fashion as a click pen.

The tapping by the conductive tip 710 on the touch panel can be interpreted similarly as the modulated touch signals generated using means disclosed in the embodiments above. Because the shaft 702 including the portion surrounding the opening 708 is not conductive, the touch panel can only detect a touch by the stylus when the conductive tip 710 is extended to be in contact with (or hover over) the surface of the touch panel. When the conductive tip 710 is extended and retracted in a rapid and repeated fashion, the touch panel can detect a modulated touch signal, which can be distinguished from the steady touch signal from a finger or other objects. In other words, the modulated touch signal can then be used to determine that the touch object is a stylus.

In one embodiment, the end portion of the stylus 700 with the opening 708 can rest on the touch panel while the retractable conductive tip 710 is extended and retracted. In this embodiment, the conductive tip 710 does not extend beyond the opening 708. Because the shaft is an insulator, the touch panel can only detect the repeated touches by the conductive tip 710, but not the stationary shaft.

In various embodiments, the controller 706 can provide different control mechanisms for mechanically extending and retracting the conductive tip 710. For example, in one embodiment, the controller 706 can include an electronically operated switch, such as a miniature relay, to drive the retractable tip 710. The switch can be connected to an MCU (not shown in FIG. 7) which can set the frequency at which the retractable tip taps on a touch panel. The frequency of the tapping can be used as the touch signature of the stylus 700 to identify the stylus 700 to the touch panel.

The different mechanisms for initiating the modulated signal discussed above with respect to FIGS. 3-6 can be incorporated into the stylus of FIG. 7.

As described in the embodiments above, the frequency of the touch signal of the stylus can be generated by an MCU. Additionally or alternatively, the frequency of the touch signal can also be generated using an RC or RLC circuit. In a typical RLC circuit, voltage applied across the capacitor can cause energy to be transferred between the inductor and the capacitor. Therefore, this type of circuit can have a naturally oscillated signature. In some embodiments of this disclosure, this signature can be used to generate a pulsed touch signal for a stylus. For example, the resistance and/or the capacitance of the resistor and capacitor of the RLC circuit, respectively, can be changed based on various conditions of the stylus, such as a pressure change sensed at its tip when the stylus makes contact with a touch panel. FIG. 8 illustrates a stylus 800 according to an embodiment of this disclosure. The stylus 800 includes a tip 810 movable in the vertical direction and connected to an RLC circuit 820. Similar to the stylus of FIG. 6, the movable tip 810 can be forced upwards when the stylus 800 makes contact with a touch panel. The movement of the tip 810 can cause the capacitance of the capacitor and/or the resistance of the resistor of the RLC circuit 820 to change, thereby changing the oscillation signature of the RLC circuit 820. The oscillation signature of the RLC circuit 820 can then be used to modulate the touch signal of the stylus 800. In this embodiment, the RLC circuit 820 can control the touch signal of the stylus 800 through a switch 840 in a similar way that the MCU 206 modulates the touch signature of the stylus 200 in FIG. 2. In this embodiment, the stylus 800 may not require a MCU. The MCU, controller, RC or RLC circuits described above may be referred to generally herein as control circuitry.

In other embodiments, the modulated touch signal from the stylus can be used for more than identifying the stylus to a touch sensitive device. It can also be used for transmitting data from the stylus to the touch sensitive device. That is, certain conditions of the stylus or other information can be encoded in the modulated touch signal by the MCU. For example, referring again to the stylus 800 of FIG. 8, when the oscillation signature of the RLC circuit 820 changes as a result of the external pressure, the touch signal of the stylus 800 can change accordingly. Thus, a touch panel can determine, based on the change in the touch signal of the stylus 800, that the stylus has transitioned from hovering to touching. Additionally or alternatively, the amount of change in the touch signal can reflect the change in capacitance of the RLC circuit 820, which in turn can reflect the amount of force sensed at the tip of the stylus 800. As another example, data collected by an accelerometer 416 (FIG. 4) reflecting the tilt or barrel roll of a stylus 400 can similarly be transmitted to a touch panel from the stylus 400 using a pulsed touch signal with a uniquely identifiable frequency. In one embodiment, for example, such data can be encoded using Morse code.

In various embodiments, the touch signal of the stylus can be modulated at any frequency. When detected by the touch panel, this pulsed signal can appear to be amplitude modulation, which is different from the steady signal from a finger or any other touch objects. Accordingly, the touch panel can recognize that the touch object on its surface is in fact a stylus. One advantage of the disclosed embodiments is that the stylus introduced in the embodiments of this disclosure can work with existing touch sensing devices without requiring significant modifications to the touch hardware of those devices. Therefore, it may be relatively inexpensive to implement the embodiments of this disclosure. Some changes to the software and/or firmware of the touch sensing device may be required so that the device can recognize the different touch signals and match them with different styluses or touch objects. For example, the software/firmware can recognize that a stylus is in contact with the touch surface when a pulsed touch signal is detected. In some embodiments, different styluses can have their touch signals modulated at different frequencies so that the touch panel can identify not only that it is a stylus, but also a particular stylus. Essentially, the modulation frequency can be the touch signature of a particular stylus or any other touch object.

In one embodiment, the various modulation frequencies can be stored in a memory of the touch sensing device and recalled by the processor during operation to find a match for a particular stylus detected by the touch panel. Because software updates can be easily carried out even after the touch sensing device is manufactured and put to use, this makes it possible to implement embodiments of the disclosure using existing multi-touch enabled electronic devices. In other embodiments, the same concept can be implemented in other touch objects such that different types of touch objects or different touch objects can be identified by the touch sensing device based on the frequency at which their touch signals modulate.

An existing touch sensing device may respond to a touch by a finger or a conventional stylus the same way because the touch signals from the finger and the conventional stylus can be very similar. However, given the additional capability to differentiate between a touch by a stylus disclosed in one of the embodiments of this disclosure from a touch by a finger (or by other touch objects), the touch sensing device can be modified to respond differently to touches by different touch objects. For example, if the touch sensing device recognizes a stylus from its pulsed signal, it can automatically initiate a character recognition and/or word processing program that allows the user to directly write on the touch screen using the stylus. In contrast, if the touch sensing device determines that a finger is in contact with the touch screen, it can initiate tracking or pointing operations based on the movement of the finger. In a multi-touch enabled touch sensing device, the device can detect one touch by a finger and another touch by a stylus based on their respective touch signals. If a drawing application is running on the touch screen, the user can draw with a stylus and use his finger to create other effects at the same time. Thus, more sophisticated functions can be performed via the touch panel and an improved user experience can be achieved by incorporating the various embodiment of this disclosure.

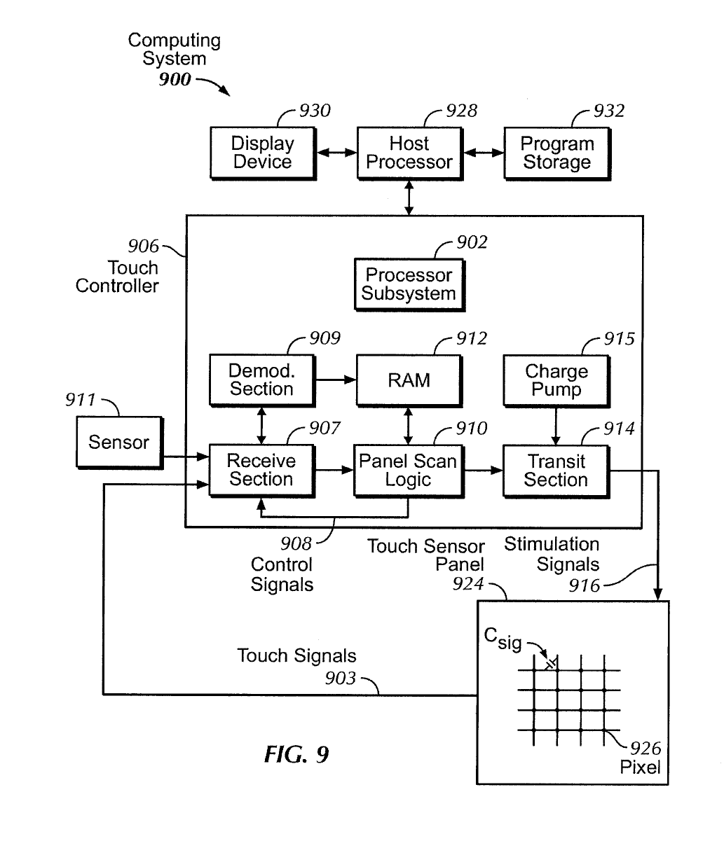

FIG. 9 illustrates an exemplary computing system that can use a stylus according to various embodiments. In the example of FIG. 9, computing system 900 can include touch controller 906. The touch controller 906 can be a single application specific integrated circuit (ASIC) that can include one or more processor subsystems 902, which can include one or more main processors, such as ARM968 processors or other processors with similar functionality and capabilities. However, in other embodiments, the processor functionality can be implemented instead by dedicated logic, such as a state machine. The processor subsystems 902 can also include peripherals (not shown) such as random access memory (RAM) or other types of memory or storage, watchdog timers and the like. The touch controller 906 can also include receive section 907 for receiving signals, such as touch (or sense) signals 903 of one or more sense channels (not shown), other signals from other sensors such as sensor 911, etc. The touch controller 906 can also include demodulation section 909 such as a multistage vector demodulation engine, panel scan logic 910, and transmit section 914 for transmitting stimulation signals 916 to touch panel 924 to drive the panel. The scan logic 910 can access RAM 912, autonomously read data from the sense channels, and provide control for the sense channels. In addition, the scan logic 910 can control the transmit section 914 to generate the stimulation signals 916 at various frequencies and phases that can be selectively applied to rows of the touch panel 924.

The touch controller 906 can also include charge pump 915, which can be used to generate the supply voltage for the transmit section 914. The stimulation signals 916 can have amplitudes higher than the maximum voltage by cascading two charge store devices, e.g., capacitors, together to form the charge pump 915. Therefore, the stimulus voltage can be higher (e.g., 6V) than the voltage level a single capacitor can handle (e.g., 3.6 V). Although FIG. 9 shows the charge pump 915 separate from the transmit section 914, the charge pump can be part of the transmit section.

Computing system 900 can include host processor 928 for receiving outputs from the processor subsystems 902 and performing actions based on the outputs that can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. The host processor 928 can also perform additional functions that may not be related to touch processing, and can be connected to program storage 932 and display device 930 such as an LCD for providing a UI to a user of the device. Display device 930 together with touch panel 924, when located partially or entirely under the touch panel, can form a touch screen.

Touch panel 924 can include a capacitive sensing medium having drive lines and sense lines. It should be noted that the term “lines” can sometimes be used herein to mean simply conductive pathways, as one skilled in the art can readily understand, and is not limited to structures that can be strictly linear, but can include pathways that change direction, and can include pathways of different size, shape, materials, etc. Drive lines can be driven by stimulation signals 916 and resulting touch signals 903 generated in sense lines can be transmitted to receive section 907 in touch controller 906. In this way, drive lines and sense lines can be part of the touch and hover sensing circuitry that can interact to form capacitive sensing nodes, which can be thought of as touch picture elements (touch pixels), such as touch pixels 926. This way of understanding can be particularly useful when touch panel 924 can be viewed as capturing an “image” of touch. In other words, after touch controller 906 has determined whether a touch or hover has been detected at each touch pixel in the touch panel, the pattern of touch pixels in the touch panel at which a touch or hover occurred can be thought of as an “image” of touch (e.g. a pattern of fingers touching or hovering over the touch panel).

A stylus according to various embodiments can be used to contact the touch panel 924. The stylus orientation can provide additional information to the computing system 900 for improved performance.

Note that one or more of the functions described above, can be performed, for example, by firmware stored in memory (e.g., one of the peripherals) and executed by the processor subsystem 902, or stored in the program storage 932 and executed by the host processor 928. The firmware can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

It is to be understood that the touch panel, as described in FIG. 9, can sense touch and hover according to various embodiments. In addition, the touch panel described herein can be either single- or multi-touch.

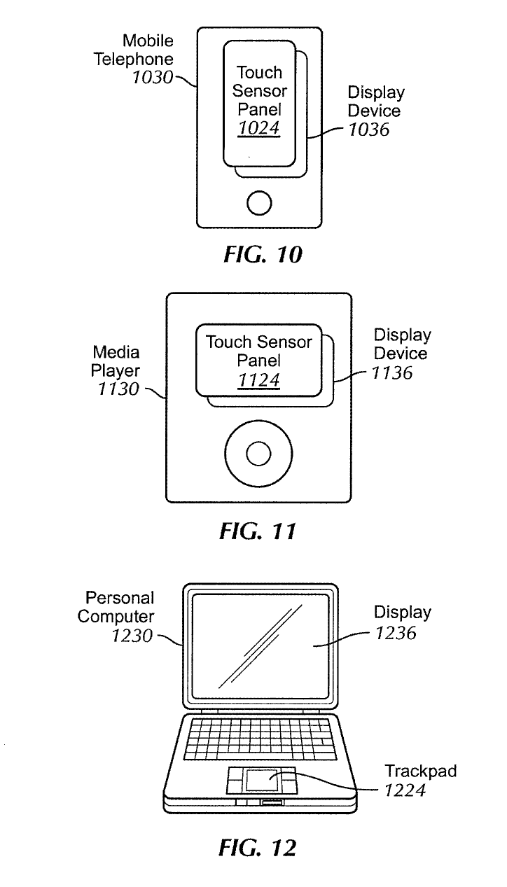

FIG. 10 illustrates an exemplary mobile telephone 1030 that can include touch panel 1024, display device 1036, and other computing system blocks for use with a stylus according to various embodiments.

FIG. 11 illustrates an exemplary digital media player 1130 that can include touch panel 1124, display device 1136, and other computing system blocks for use with a stylus according to various embodiments.

FIG. 12 illustrates an exemplary personal computer 1230 that can include touch pad 1224, display 1236, and other computing system blocks for use with a stylus according to various embodiments.

The mobile telephone, media player, and personal computer of FIGS. 10 through 12 can improve touch and hover sensing and preserve power by utilizing a stylus according to various embodiments.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

What is claimed is:

1. A stylus comprising;
a shaft;
a conductive tip at a distal end of the shaft; and
control circuitry coupled to the conductive tip and configured to generate a modulated signal at the conductive tip to identify the stylus.

2. The stylus of claim 1, further comprising:
a switch coupled between the conductive tip and the shaft;
wherein the control circuitry is further configured to control the switch to modulate a conductive path between the conductive tip and the shaft to generate the modulated signal.

3. The stylus of claim 1, further comprising an accelerometer coupled to the control circuitry and configured to detect movement of the stylus, the control circuitry further configured to initiate or terminate the modulated signal in response to a detected existence or absence of stylus movement.

4. The stylus of claim 1, wherein the shaft includes a touch sensor coupled to the control circuitry for detecting contact by a user, the control circuitry further configured to initiate or terminate the modulated signal in response to a detected existence or absence of user contact.

5. The stylus of claim 1, further comprising a pressure sensor coupled to the control circuitry and configured to sense force generated from a contact between the stylus and a surface, the control circuitry further configured to initiate or terminate the modulated signal in response to a detected existence of absence of force.

6. The stylus of claim 1, further comprising a pushbutton switch coupled to the control circuitry, the control circuitry further configured to initiate or terminate the modulated signal in response to a detected activation or deactivation of the pushbutton switch.

7. The stylus of claim 1, the control circuitry further configured for encoding data reflecting a condition of the stylus into the modulated signal, the condition being one of tilt, barrel roll, pressure sensed on the conductive tip, and whether the stylus is in contact with or hovering over the touch panel.

8. The stylus of claim 1, wherein the control circuitry comprises an RLC circuit.

9. The stylus of claim 8, further comprising a pressure sensor, wherein the RLC circuit is initiated by the pressure sensor.

10. The stylus of claim 8, wherein the modulated signal has a frequency based on an oscillating signature of the RLC circuit.

11. The stylus of claim 1, the control circuitry further configured for generating the modulated signal at a particular frequency to identify a type of the stylus.

12. The stylus of claim 1, wherein the control circuitry is configured to extend and retract the conductive tip from within the shaft at a predetermined frequency to generate the modulated signal when the conductive tip makes contact with a surface.

13. The stylus of claim 12, wherein the control circuitry comprises an electronically operated switch to drive the conductive tip.

14. A method for generating a signature for identifying an object on a touch panel, comprising:
modulating a tip of the object, the tip located on the object for contacting the touch panel;
wherein the modulation identifies the object as being other than a finger.

15. The method of claim 14, wherein modulating the tip comprises repeatedly switching the tip between a grounded and an ungrounded state.

16. The method of claim 14, wherein modulating the tip comprises repeatedly extending and retracting the tip with respect to the object.

17. The method of claim 14, wherein the modulation identifies a type of the object.

18. The method of claim 14, further comprising initiating or terminating the modulation depending on a detected existence or absence of object movement.

19. The method of claim 14, further comprising initiating or terminating the modulation depending on a detected existence or absence of a touch or force on the object.

20. The method of claim 14, further comprising initiating or terminating the modulation depending on a physical condition of the object, the physical condition being one of tilt, barrel roll, pressure sensed at the tip, and whether the tip is in contact with or hovering over the touch panel.

21. A non-transitory computer-readable storage medium storing computer-readable program instructions executable to perform a method for generating a signature for identifying an object on a touch panel, the method comprising:
modulating a tip of the object, the tip located on the object for contacting the touch panel;
wherein the modulation identifies the object as being other than a finger.

22. The non-transitory computer-readable storage medium of claim 21, wherein modulating the tip comprises repeatedly switching the tip between a grounded and an ungrounded state.

23. The non-transitory computer-readable storage medium of claim 21, wherein modulating the tip comprises repeatedly extending and retracting the tip with respect to the object.

24. The non-transitory computer-readable storage medium of claim 21, wherein the modulation identifies a type of the object.

25. A method for identifying a touch object on a touch panel, comprising:
detecting a modulated touch signal from the touch object; and
determining whether the modulated touch signal has a frequency above a predetermined value.
